(19) United States
(12) Patent Application Publication
(10) Pub. No.: US 2007/0000385 A1
(43) Pub. Date: Jan. 4, 2007

(54) Adsorbents for removing H2S, other odor causing compounds, and acid gases from gas streams and methods for producing and using these adsorbents

(76) Inventor: Mark R. Stouffer, Middletown, CT (US)

Correspondence Address: COHEN & GRIGSBY, P.C., 11 STANWIX STREET, 15TH FLOOR, PITTSBURGH, PA, 15222, US

(21) Appl. No.: 11/173,096

(22) Filed: Jul. 1, 2005

(51) Int. Cl. B01D 53/02

(52) U.S. Cl. 95/136

(57) ABSTRACT

Adsorbents for removing H₂S, other odor-causing compounds, and other acid gases from gas streams, as well as methods for manufacturing and using adsorbents, are provided. Adsorbents comprise a porous media in which at least one metal oxide is primarily distributed on or over the surface of the pores of the media. In an example, the porous media is activated carbon and the metal oxide is magnesium oxide. The adsorbents of the present invention are particularly useful for removing odor caused by hydrogen sulfide and organic sulfinur compounds that are common at municipal waste treatment plants, paper mills and industrial plants.

### FIELD OF INVENTION

The present invention relates to adsorbents for removing hydrogen sulfide, other odor-causing compounds and acid gases from a gas stream adjacent thereto, and methods for producing and using these adsorbents.

### BACKGROUND OF THE INVENTION

Hydrogen sulfide (H₂S) is characterized by a well-known “rotten egg” odor and is prevalent at most wastewater treatment plants and at industrial plants such as paper mills. Although hydrogen sulfide can be fatal at high concentrations in the gaseous phase, the need for treatment is generally governed by the objectionable odor. In many cases, hydrogen sulfide is accompanied by other odor-causing compounds, such as mercaptans, other organic sulfur compounds, and non-sulfur organic compounds.

Several adsorbents for removing H₂S from gas streams are known in the art. For example, activated carbon is known to remove hydrogen sulfide from both gaseous and aqueous phases. However, the reaction rate and the hydrogen sulfide loading on the activated carbon limit the economic viability of the activated carbon. Using ASTM Method D-6646 testing protocol, a typical coal based activated carbon has a hydrogen sulfide of 0.01 to 0.02 g/cc.

Given this shortcoming, methods have been employed to modify activated carbon and improve the capacity of the carbon for H₂S. For example, activated carbon has been impregnated with caustic compounds such as sodium hydroxide (U.S. Pat. No. 4,215,096 Sinha et al) or potassium hydroxide to increase the rate of the oxidation reaction of hydrogen sulfide to elemental sulfur and sulfuric acid. These caustic impregnated materials have an H₂S capacity of about 0.14 g/cc, which is an improvement over the non-impregnated activated carbon. Unfortunately, improvement in the hydrogen sulfide capacity of these caustic-impregnated materials is unlikely since the pore structure of the adsorbent has been filled with the impregnant. Further, these caustic impregnated media are susceptible to uncontrolled thermal excursions, resulting from a suppressed combustion temperature and exothermic reactions caused by the caustic impregnation. Finally, the filling of the media pore structure inhibits the adsorption of other compounds that do not chemically react with the caustic component of the media.

Catalytic carbons improve upon the deficiencies of the caustic impregnated media (U.S. Pat. No. 5,356,849 by Matviya and Hayden, and U.S. Pat. No. 5,494,869 by Hayden and Butterworth). The catalytic carbons overcome two of the deficiencies associated with the caustic impregnated media. First, the catalytic carbons do not exhibit the reduced combustion temperature that the caustic impregnated activated carbons experience, and second, the catalytic carbons do not exhibit the reduced adsorption capacity for those compounds that do not chemically react with the adsorbent. A further improvement over the caustic impregnated carbons is that the catalytic carbons can be regenerated using a water wash of the media, which generates a dilute sulfuric acid solution. Unfortunately, these performance improvements come at a price because the H₂S capacity of the catalytic carbon is generally about 0.09 g/cc.

Metal oxides are also known to catalyze the oxidation of H₂S to sulfates and/or elemental sulfur. However, pure metal oxides have a limited capacity for H₂S because of their low pore volume and surface area, and the oxidation reaction of H₂S is too slow to have any practical application to odor control. Finally, the pure metal oxides do not exhibit significant adsorption capacity for organic compounds that do not react with the substrate. As a result, these metal oxides are not commercially relevant.

Most recently, it has been shown that uniformly dispersing metal oxides throughout an activated carbon matrix improves the ability of that activated carbon to remove H₂S from a gas stream (U.S. Pat. No. 6,858,192 by Graham and Yuan). H₂S capacities are claimed to be about 0.25 g/cc, which is a significant improvement over the caustic impregnated activated carbon, the catalytic carbon and obviously, a typical activated carbon. Unfortunately, the process for preparing this high hydrogen sulfide capacity carbon leaves significant amounts of the active agent unavailable for reaction.

Each of these methods of oxidation of H₂S previously known in the art suffers from at least one of the following disadvantages: the activated carbon has a low capacity for H₂S; the activated carbon has a slow kinetic rate of H₂S removal; the adsorption capacity is low for compounds that do not react with the active component; relatively high amounts of metal oxide must be dispersed throughout the carbon matrix; and such methods often have limited application.

### SUMMARY OF THE INVENTION

The present invention is directed towards an adsorbent media or material that satisfies the need for an H₂S adsorbent that has a high capacity for H₂S, a high kinetic rate of removal, and a high capacity for compounds that do not react with the active component of the adsorbent. Accordingly, it is an object in an embodiment of the invention to provide an adsorbent material that has a substantially improved H₂S capacity and high kinetic rate compared to that of current commercial impregnated and catalytic carbons.

It is still a further object in an embodiment of the invention to provide an adsorbent material that also has a capacity for odor-causing compounds besides H₂S, such as, for example, mercaptans and alkyl sulfides.

It is still a further object in an embodiment of the invention to provide an adsorbent material that requires a minimal amount of metal oxide.

It is a further object in an embodiment of the invention to provide a method of manufacture of an adsorbent material having an improved H₂S capacity.

It is still a further object in an embodiment of the invention to provide a method of using an adsorbent material to remove H₂S, organic compounds, organic sulfur compounds, and/or acid gases.

The present invention is directed to an adsorbent for removing H₂S, organic compounds, organic sulfur compounds, and/or acid gases from a gas surrounding the adsorbent. The adsorbent comprises a metal oxide and a porous media having a plurality of pores. The metal oxide is either magnesium oxide, calcium oxide, or a combination thereof. The metal oxide is primarily distributed on or over the surface of each of the pores of the porous media, i.e. the internal surface of the porous media. In an embodiment, the adsorbent also removes organic compounds and/or organic sulfur compounds. In another embodiment, the adsorbent also removes acid gases.

In another example, the invention is also directed to a method of manufacturing the adsorbent. The method comprises providing a porous media; impregnating the porous media with a solution of a metal salt so that the metal salt is primarily distributed on or over the surface of each of the pores of the porous media; and converting the metal salt to a metal oxide.

In another example, the invention is also directed to a method of using the adsorbent to remove H₂S, organic sulfur compounds and/or organic compounds from a gas. The method of use comprises the steps of: contacting a portion of the gas with the adsorbent; and obtaining a treated gas having a concentration of H₂S, organic sulfur compounds and/or organic compounds that is less than the initial concentration in the gas prior to contact with the adsorbent.

In another example, the invention is directed to a method of using the adsorbent to remove acid gases in addition to or instead of H₂S. The method of use comprises the steps of: contacting a portion of the gas with the adsorbent; and obtaining a treated gas having an acid gas concentration that is less than the initial concentration in the gas prior to contact with the adsorbent. The acid gases include, but are not limited to, for example sulfur dioxide and hydrogen chloride.

### BRIEF DESCRIPTION OF THE DRAWINGS

FIG. 1 is a graph that compares the H₂S capacities (g/cc) of adsorbents of the present invention with those of adsorbents previously known in the art.

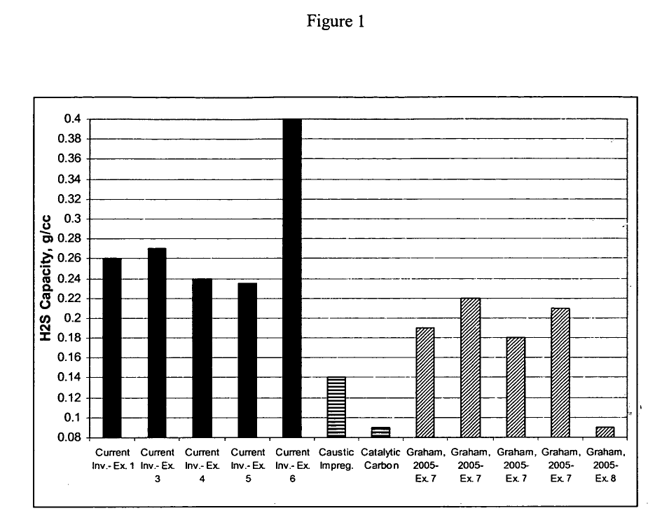

FIG. 2 is a graph comparing the methyl mercaptan capacity (g/100 g) of an embodiment of an example of the present adsorbent with the methyl mercaptan capacities of various other adsorbents.

### DETAILED DESCRIPTION OF THE INVENTION

The present invention provides adsorbents for removing hydrogen sulfide, odor-causing compounds, and acid gases from gas streams surrounding the adsorbent. In an example, the odor-causing compound is an organic sulfur compound, such as, for example, mercaptans, alkyl sulfide, dimethyl sulfide, dimethyl disulfide or methyl mercaptan. In an example, the acid gas is a gas such as, for example, sulfur dioxide or hydrogen chloride. The adsorbent material comprises a metal oxide and a porous media having a plurality of pores. The metal oxide is calcium oxide, magnesium oxide, or a combination thereof. The metal oxide is primarily distributed on or over the surface of each of the pores of the porous media, as discussed in more detail below. In examples of the present invention, the adsorbent may be in the form of granules, pellets, spheres, powders, woven fabrics, non-woven fabrics, mats, felt, monolithic porous blocks, conglomerated blocks, honeycombs, or combinations thereof. This list is not intended to be limiting, however, and those skilled in the art will recognize that the present invention may exist in other forms besides those listed here.

In an example, the porous media is a carbon adsorbent. Suitable carbon adsorbents for use in the present invention may be made from any of a variety of starting carbonaceous materials, such as, but not limited to, coals of various ranks such as anthracite, semianthracite, bituminous, subbituminous, brown coals, or lignites; nutshell; wood; vegetables such as rice hull or straw; peat; residues or by-products from petroleum processing; and natural or synthetic polymeric materials.

In a preferred example, the porous material is activated carbon. Preferably, the activated carbon has a high carbon tetrachloride activity prior to distribution of the metal oxide primarily on or over the surface of the pores of the activated carbon. In an embodiment, the activated carbon has a carbon tetrachloride activity greater than about 40%. In a more preferred embodiment, the carbon tetrachloride activity is greater than about 60%, and in a most preferred embodiment, the carbon tetrachloride activity is greater than about 70%. In an example, the activated carbon is a pellet having a diameter of about 4 mm. In yet another example, the activated carbon is a granule nominal 4×6 or 4×8 mesh, U.S. Sieve Series.

Metal oxides are primarily distributed on or over the surface of each pore of the porous medium. In contrast to the prior art, the metal oxide is not distributed or dispersed within or throughout the core or matrix of the porous media. Distribution of metal oxides primarily on or over the surface of each pore of the porous media yields an adsorbent material that has a substantially maximal H₂S capacity and kinetic rate, while also substantially minimizing the amount of metal oxide needed, because such a distribution allows maximum access of gas molecules to the metal oxide material. In contrast, adsorbents previously known in the art had the metal oxide dispersed within the entire matrix of the porous media, making much of the magnesium oxide inaccessible to gas. For an example, the adsorbents of the present invention have an H₂S capacity of about 0.10 to 0.30 g/cc, equivalent to or about two to three times that of currently commercially available caustic impregnated and catalytic carbons. In a further example of the present invention, the adsorbents have a SO₂ capacity of three times that of standard unimpregnated activated carbons, such as the WS-480 (discussed below).

The metal oxide is selected from the group consisting of oxides of magnesium, calcium or a combination thereof. In an example of an embodiment of the invention, magnesium is present as magnesium oxide at a level of about 0.1 to about 15% (as Mg) of the weight of the adsorbent material. In a preferred example of an embodiment, the concentration of Mg by weight is about 1 to 10% of the weight of the adsorbent material, and in a more preferred embodiment magnesium is present at a concentration of about 2-6% of the weight of the adsorbent material. In another example of an embodiment of the invention, calcium is present as calcium oxide at a level of about 0.1 to about 15% (as Ca) of the weight of the adsorbent material. In a preferred example of an embodiment, the concentration of Ca by weight is about 1 to 10% of the weight of the adsorbent material, and in a more preferred embodiment calcium is present at a concentration of about 2-6% of the weight of the adsorbent material.

In an example of an embodiment of the present invention, the adsorbent removes hydrogen sulfide, organic sulfur containing compounds, organic compounds, and/or acid gases from the surrounding medium. In the present invention, the amount of metal oxide required is minimized (as discussed in the Examples provided below), thereby enhancing the capacity of the adsorbent for organic materials. In examples, the adsorbents of the present invention have a capacity for mercaptans, an organic odor-causing compound, that is substantially higher than that of adsorbents known in the prior art, such as, for example, caustic impregnated carbons or carbons having magnesium oxide evenly distributed in the carbon matrix.

The H₂S capacity of adsorbents of the present invention, ranging from about 0.10 to about 0.30 g/cc, is much larger than that of carbon adsorbents previously known in the art. These H₂S capacities were measured by testing the carbon adsorbents bone dry with no pre-humidification per ASTM Method D-6646 (Determination Of The Accelerated Hydrogen Sulfide Breakthrough Capacity Of Granular And Pelletized Activated Carbon). This higher capacity, in addition to the capacity of the adsorbents of the present invention for organic compounds, will be important in large-scale odor control applications such as municipal sewage plants, where achieving acceptable odor reduction often depends upon removal of H₂S, organic sulfinur compounds, and organic compounds.

The present invention also provides for the method of manufacturing the adsorbent media. In an embodiment, a porous media, such as, for example, the carbon adsorbents or activated carbon, as described above, is impregnated with a solution of at least one metal salt so that the metal salt is primarily distributed on or over the surface of each of the pores of the porous medium, i.e., the internal surface of the porous medium. The method of manufacturing also comprises the step of converting the metal salt to a metal oxide.

Impregnation may be achieved by pouring the metal salt solution over the porous medium, dipping the porous medium into the metal salt solution, or spraying the porous medium with the metal salt solution. In an embodiment, the metal salt solution is sprayed onto or over the porous medium until substantially all of the pores of the porous medium are filled with the metal salt solution such that when the solvent is driven off, the metal oxide is primarily distributed on or over the surface of each pore of the porous medium. In other embodiments, the metal salt solution is poured over the porous medium or the porous medium is dipped in the metal salt solution to the point of incipient wetness.

Impregnation results in distribution of the metal salt primarily on or over the surface of the pores. A single adsorbent may be manufactured from one type of metal salt or from a combination of types of metal salts. For examples, salts may be halides, nitrates, sulfates, chlorates, and carboxylates having from one to five carbon atoms such as formates, acetates, oxalates, malonates, succinates, glutarates, or combinations thereof. This list is not intended to be limiting, however, and those skilled in the art will recognize that other salts of a metal may be used in the method of manufacture of the present invention. For examples, the metal salt may be magnesium acetate, calcium acetate, or a mixture of magnesium and calcium acetates. As one example, magnesium acetate may be produced by reacting magnesium hydroxide with acetic acid. As yet another example, the metal salt may be calcium magnesium acetate (CMA).

The dispersed metal salt is converted to metal oxide by any thermal decomposition or chemical reaction known in the art. For an example, the temperature may be raised above the equilibrium decomposition point of the salt so that magnesium acetate converts to magnesium oxide with the release of water and volatile organics.

Optionally, the method of manufacture may further comprise the step of activation of the adsorbent using steam, such as for example, heating the porous material to above 800° C. in the presence of steam. Activation of the adsorbent using steam may exclude oxygen from the reaction so that the porous medium does not burn, and may have the further advantage of increasing the pore volume of the porous media. In an example, the steam activation is performed concurrently with the thermal decomposition or chemical reactions. In yet another example, steam activation is performed after the dispersed metal salts are converted to metal oxides.

Optionally, the method of manufacture may further comprise the step of heating in a nitrogen atmosphere the activated adsorbent having the metal salt distributed primarily on or over the surface of the pores. This step may substitute for the steam activation described above, or may be in addition to the steam activation.

Optionally, the method of manufacture may further comprise the step of activation of the adsorbent using air or carbon dioxide alone or in combination with the gases noted above.

The present invention also provides for a method of using the adsorbent material to remove H₂S and/or organic compounds from a gas stream. A portion or all of the gas entering the vessel or reactor is contacted with the adsorbent, resulting in adsorption of the H₂S, organic compounds, organic sulfur compounds, and/or acid gases to the activated adsorbent such that the metal oxide catalyzes the oxidation of H₂S to sulfates and/or elemental sulfur. For an example, such contact may occur by passing a gas stream through, for examples, a fixed bed, a fluidized bed, or a moving bed of the adsorbent material. The bed is within a housing that has an inlet and an outlet. A stream of gas or acid gas enters the inlet and flows through the bed of the adsorbent material and contacts the adsorbent. The stream then leaves through the outlet. The resultant gas following this contact has a lower concentration of H₂S, organic compounds, and/or other acid gases than what was present in the gas prior to the contact.

### EXAMPLES OF THE PRESENT INVENTION

The following examples illustrate several embodiments of the present invention. In the following examples, the H₂S capacity of the carbon adsorbents was determined by testing the carbon adsorbents bone dry with no pre-humidification per ASTM Method D-6646 (Determination Of The Accelerated Hydrogen Sulfide Breakthrough Capacity Of Granular And Pelletized Activated Carbon). Details of experiments using sulfur dioxide to represent other acid gases also are provided.

### Example 1

In an example, a pelletized activated carbon, WS-480 (Calgon Carbon Corp., Pittsburgh, Pa.) was used as the porous material. WS-480 had a nominal carbon tetrachloride activity of about 80% and nominal particle diameter of about 4 mm. A solution of magnesium acetate made from about 45 g of magnesium acetate tetrahydrate was sprayed over about 100 g of WS-480 activated carbon to primarily distribute the metal oxide on or over the surface of each pore of the porous media. The resulting carbon was just below the point of incipient wetness, that is, the pores of the carbon were filled with solution so that metal oxide was primarily distributed on or over the internal surface of the carbon, while there was little or no solution on the external surface of the carbon. The activated carbon having the magnesium acetate tetrahydrate primarily distributed on or over the surface of the pores was heat treated in a rotary kiln at 850° C. in a nitrogen atmosphere for 30 minutes. The resultant carbon adsorbent had about 5.1 g Mg per 100 g carbon, with Mg present as MgO, and an H₂S capacity of about 0.26 g/cc, approximately two to three times higher than that of caustic-impregnated and catalytic carbons previously known in the art and currently used in commercial odor control applications.

### Example 2

In another example, a solution of magnesium acetate tetrahydrate made from about 22 g of magnesium acetate tetrahydrate was sprayed onto about 100 g of WS-480 activated carbon to primarily distribute the metal salt solution on or over the surface of the pores of the carbon, as described in Example 1, above. The activated carbon having the magnesium acetate tetrahydrate primarily distributed on or over the surface of the pores was heat treated in a rotary kiln at 800° C. in a nitrogen atmosphere for 30 minutes. The resultant carbon adsorbent had about 2.5 g Mg per 100 g carbon, with Mg present as MgO, and an H₂S capacity of about 0.21 g/cc. Thus, the carbon adsorbent manufactured by the method of manufacture of the present invention yields an adsorbent having an H₂S capacity that is higher than that of caustic-impregnated and catalytic carbons previously known in the art and currently used in commercial odor control applications, while only requiring about half of the magnesium acetate. These data suggest that the optimum magnesium content is in the range of about 0.1 to 15% and preferably in the range of about 2.0 to about 10.0%.

### Example 3

In yet another example, a pelletized activated carbon, 207E4 (Calgon Carbon, Columbus, Ohio) was used as the porous material. The 207E4 carbon had a nominal carbon tetrachloride activity of about 70% and a particle diameter of about 4 mm. The metal salt used was Calcium Magnesium Acetate (CMA) (Cryotech Corp.), a mixture of calcium acetate and magnesium acetate (in about a 3:7 Ca:Mg molar ratio). The CMA solution was sprayed onto the 207E4 carbon. After the CMA solution was primarily distributed on or over the surface of each of the pores of the porous media, the carbon was heat treated at 850° C. in a steam atmosphere for 30 minutes to convert the magnesium salts to oxides and to additionally activate the carbon by reaction with steam by heating the carbon to above 800° C. in the presence of steam. As discussed above, steam was used to exclude oxygen, substantially preventing the activated carbon from burning, and also increasing the pore volume of the carbon. The resultant adsorbent carbon had an H₂S capacity of about 0.27 g/cc. This example shows that in an embodiment of the present invention, an inexpensive raw material containing a mixture of metal compounds can be used to produce an adsorbent carbon.

### Example 4

In yet another example of an embodiment of the present invention, a magnesium acetate solution made from about 12 g of magnesium hydroxide was sprayed onto 100 g 207E4 carbon. The carbon was then treated in steam at 900° C. for 30 minutes to convert the magnesium salts to oxides and to additionally activate the carbon by reaction with steam, as described in Example 3, above. The resultant carbon adsorbent had about 5 g Mg per 100 g carbon and an H₂S capacity of about 0.24 g/cc. This example illustrates another means of producing the adsorbent of the present invention with inexpensive and readily available raw materials.

### Example 5

In yet another example of an embodiment of the invention, the method used in Example 4, above, was repeated, except that about 9.6 g magnesium acetate was used to yield a carbon adsorbent having about 4 g Mg per 100 g carbon and an H₂S capacity of about 0.235 g/cc. Again, this example demonstrates that the adsorbent of the present invention can be produced with inexpensive and readily available raw materials.

### Example 6

In another example, a granular activated carbon produced from coconut shells was used as the base material. It had a carbon tetrachloride activity of about 100% and a particle size of about 12×20 mesh. A magnesium acetate solution was produced from 12 g of magnesium hydroxide. The resulting magnesium acetate solution was sprayed onto 100 g carbon. This was heat treated in steam at 900° C. for 30 min. The resultant adsorbent carbon had about 5 g Mg per 100 g carbon and an H₂S capacity of about 0.40 g/cc. This demonstrates that an even higher H₂S capacity can be achieved by using a base carbon having a higher porosity.

### EXAMPLES OF THE PRIOR ART

### Example 7

In this example, the adsorbent carbons produced by the method of manufacture of the present invention described in Examples 1-6 above, wherein metal oxides are primarily distributed on or over the internal surface of the carbons, were compared with carbons (obtained from U.S. Filter Corp.) that were manufactured according to a method available in the prior art, wherein metal oxides are dispersed throughout the carbon matrix. The H₂S capacities of four different prior art carbon samples are shown in the table below:

TABLE 1
Hydrogen Sulfide Capacity of Prior Art Carbon Samples

| Prior Art Sample | H₂S Capacity |
|---|---|
| Midas ® OCM (Received September 2004) | 0.19 g/cc |
| Midas ® OCM (September 2004 sample 2) | 0.22 g/cc |
| Midas ® OCM (September 2003) | 0.18 g/cc |
| Midas ® OCM (May 2003) | 0.21 g/cc |

Analysis of the September 2003 sample by Proton Induced X-ray Emission Spectrometry (PIXE), a method of elemental analysis, showed a Mg content of about 8.14 wt %. Therefore, the adsorbent carbon produced by the method of manufacture of the present invention, and shown in Examples 1-5, above, is superior in at least two respects: first, the method of manufacture of the present invention produces adsorbent carbons having higher H₂S capacities than those produced by methods of manufacture of the prior art; and second, the method of manufacture of the present invention uses less metal oxide than the method of manufacture of the prior art.

### Example 8

In yet another example, a sample of CANE CAL, a commercially available carbon from Calgon Carbon Corporation, Pittsburgh, Pa., was manufactured according to the method of the prior art in order to compare to the method of manufacture of the present invention. Bituminous coal was pulverized. MgO was added to the coal with a binder and briquettes were formed from this mixture. The MgO-containing briquettes were then sized to 4×6 mesh. This material was oxidized and partially devolatilized. Finally, the material was steam activated to a carbon tetrachloride activity of about 65%. The resultant Mg content was about 8 g/100 g and the measured H₂S capacity was about 0.09 g/cc. Thus, again, these data demonstrate that the methods of manufacture of the prior art produce lower H₂S capacity than the method of manufacture of the present invention (see Examples 1-5, above).

### Example 9

In yet another example of the prior art, the CANE CAL activated carbon material was produced by the same method described in Example 7. The measured H₂S capacity was 0.02 g/cc.

### Example 10

In yet another example of the adsorbent manufactured according to the method of the prior art, an adsorbent was manufactured according to the method of Graham and Yuan, using coconut shell as the base material. Coconut char was pulverized. MgO was added to the char with a binder and this mixture was extruded into 4-mm pellets. The MgO-containing pellets were then steam activated to a carbon tetrachloride activity of about 64%. The target Mg content was about 8 g/100 g and the measured H₂S capacity was about 0.14 g/cc. These data demonstrate that the adsorbents manufactured according to the present invention (as in Examples 1-5 above) have a higher H₂S capacity compared to that of adsorbents manufactured according to the methods of the prior art, where metal oxide is distributed evenly throughout the carbon matrix.

### Example 11

In an example of the present invention for the removal of other acid gases, sulfur dioxide (SO₂) removal was increased three fold relative to the non-impregnated activated carbon. Magnesium acetate was impregnated into WS-480 activated carbon at a ratio of 4 g of magnesium for each 100 g of activated carbon. The resulting impregnated carbon was heat treated at a temperature of about 900° C. in a steam atmosphere to effect the conversion of the acetate to the oxide. The resulting carbon adsorbent was crushed and tested for sulfur dioxide removal using the following conditions:

Carbon size: 20×50 mesh, US sieve series

Carbon volume: 93 mL

Gas flow rate: 32 L/min

Relative humidity: 50%

Temperature: 25° C.

SO₂ Influent Concentration: 500 ppmv

The test was terminated when the SO₂ concentration in the gas exiting the vessel achieved a concentration of 5.0 ppmv. The time to attain this concentration was then recorded. A longer time represents the fact that more gas can be treated and that the carbon has an increased capacity for the removal of the acid gas. In an example, the non-impregnated carbon had a SO₂ capacity of about 2 mg/cc, whereas the impregnated carbon had a SO₂ capacity of about 6.5 mg/cc. Thus, an activated carbon that represents the current invention is shown to have over three times the capacity for SO₂ than a standard activated carbon.

TABLE 2
SO₂ Capacity Test
Activated Carbon Compared to Carbon of the Current Invention

| | Test 1 | Test 2 | Average |
|---|---|---|---|
| | (minutes) | (minutes) | (minutes) |
| WS-480 | 4 | 5 | 4.5 |
| WS-480 and | 13 | 16 | 14.5 |
| 4 g Mg/100 g carbon | | | |

### Example 12

In another example, gas-phase adsorption experiments measuring the adsorption capacity of several carbons, which were produced in the Examples above, were conducted using a weakly adsorbed gas (tetrafluroethane). The following carbons were tested:
An adsorbent manufactured according to the method of the present invention, as described in Example 5 above (referred to as 207E4-4MgO)
An adsorbent manufactured according to the method of the prior art, wherein metal oxides are dispersed throughout the carbon matrix, as described in Example 7 above (referred to as US Filter Midas carbon)
Calgon Carbon Corporation IVP activated carbon, which is a commercially available caustic-impregnated carbon and which represents a media prepared according to the prior art U.S. Pat. No. 4,215,096 by Sinha et al.
The carbon adsorbent manufactured as described in Example 10 above (referred to as HTO-45-MgO).

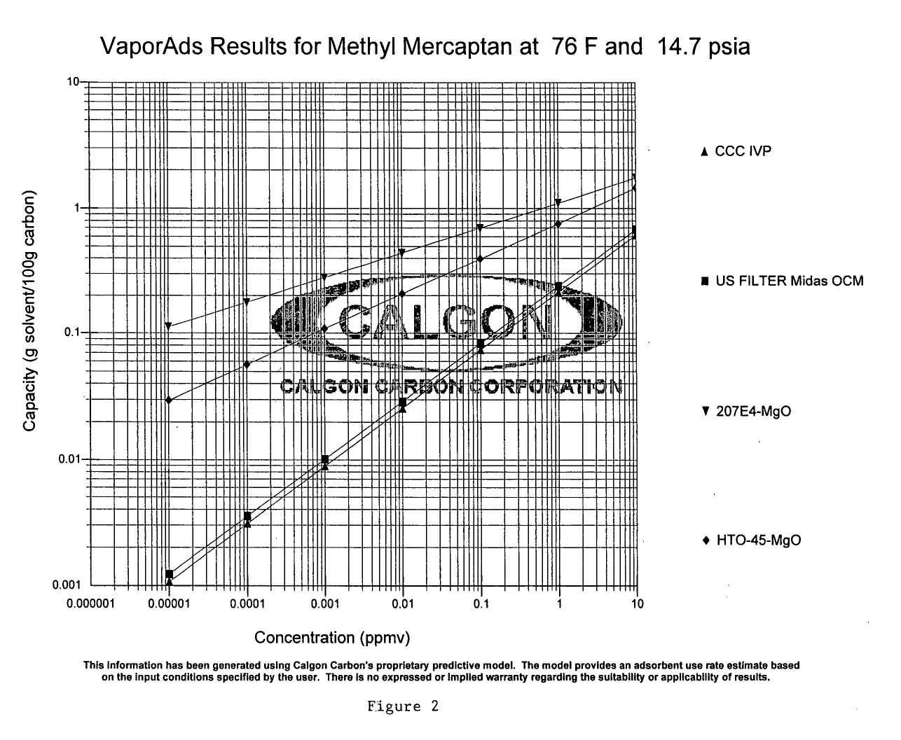

As shown in FIG. 2, the data from this experiment demonstrate that the capacity for methyl mercaptan, a common odor-causing compound that often exists together with H₂S, is higher in the carbon manufactured according to the present invention than either carbon impregnated with caustic compounds or adsorbent carbon manufactured according to the method of the prior art, wherein the metal oxides are uniformly distributed throughout the carbon matrix. These data further show that the carbon produced using this invention does not suffer a loss in adsorption capacity.

While various embodiments are described herein, it will be appreciated from the specification that various combinations of elements, variations, equivalents, or improvements therein may be made by those skilled in the art, and are still within the scope of the invention as defined in the appended claims.

What is claimed is:

1. An adsorbent for removing hydrogen sulfide, organic compounds or acid gases, or a combination thereof from a gas surrounding said adsorbent, said adsorbent comprising a metal oxide selected from the group consisting of magnesium oxide, calcium oxide and a combination thereof, and a porous media, said porous media having a plurality of pores, each of said pores having a surface, said metal oxide being primarily distributed on or over said surface of each of said pores.

2. An adsorbent as set forth in claim 1, wherein said adsorbent removes hydrogen sulfide and at least one of organic compounds, acid gases, or a combination thereof.

3. An adsorbent as set forth in claim 2, wherein said organic compounds are organic sulfur compounds, mercaptans or alkyl sulfides.

4. An adsorbent as set forth in claim 2 wherein said acid gases are sulfur dioxide or hydrogen chloride.

5. The adsorbent as set forth in claim 1 wherein said porous media is activated carbon.

6. The adsorbent according to claim 5, wherein said activated carbon is selected from the group consisting of coal-, wood-, peat-, nut shell-, petroleum residue-, vegetable-based activated carbons, and natural or synthetic polymeric materials.

7. The adsorbent according to claim 5, wherein said activated carbon has a carbon tetrachloride activity greater than about 40%.

8. The adsorbent according to claim 1 wherein said adsorbent has a form selected from the group consisting of granule, pellet, sphere, powder, woven fabric, non-woven fabric, mat, felt, honeycomb, monolithic porous block, conglomerated block, and combinations thereof.

9. The adsorbent according to claim 1, wherein said adsorbent has an H₂S capacity greater than about 0.10 g/cc, or a SO₂ capacity of greater than about 2.0 mg/cc, or both.

10. The adsorbent according to claim 1 wherein said adsorbent has a capacity for organic materials that is greater than about 0.05 g/100 g.

11. The adsorbent according to claim 1 wherein said magnesium oxide is about 0.1 to about 15% (as Mg) of the weight of said adsorbent material.

12. The adsorbent according to claim 1 wherein said calcium oxide is about 0.1 to about 15% (as Ca) of the weight of said adsorbent material.

13. The adsorbent according to claim 1 wherein said adsorbent comprises at least two metal oxides.

14. A method for manufacturing an adsorbent for removing hydrogen sulfide, organic compounds, or acid gases, or a combination thereof, said method comprising the steps of:
a. providing a porous media;
b. impregnating said porous media with a solution of at least one metal salt so that said metal salt is primarily distributed on or over a surface of pores of said porous medium; and
c. converting said metal salt into a metal oxide, wherein said metal oxide is selected from the group consisting of magnesium oxide, calcium oxide and a combination thereof.

15. The method of claim 14 wherein said solution comprises at least two metal salts, said at least two metal salts being converted to at least two metal oxides.

16. The method of claim 14 wherein said impregnation is achieved by at least one of the following:
a. pouring said metal salt solution over said porous medium;
b. dipping said porous medium into said metal salt solution; or
c. spraying said porous medium with said metal salt solution.

17. The method according to claim 14, wherein said conversion of said metal salt to said metal oxide comprises thermal decomposition or chemical reaction.

18. The method according to claim 14 further comprising the step of steam activating said adsorbent, wherein said activation can occur either concurrent with or after said conversion.

19. The method according to claim 14 or 18 further comprising the step of heating said adsorbent in a nitrogen atmosphere.

20. The method according to claim 14 further comprising the step of activating said adsorbent using air or carbon dioxide.

21. The method according to claim 14 wherein said salts are selected from the group consisting of halides, nitrates, sulfates, chlorates, carboxylates, and combinations thereof.

22. The method according to claim 14, wherein said metal salt contains at least one of magnesium, calcium, or a mixture thereof.

23. The method according to claim 14, wherein said metal salt is at least one of magnesium acetate, calcium acetate, or a mixture thereof.

24. The method according to claim 23, wherein said magnesium acetate is produced by reacting magnesium hydroxide with acetic acid.

25. The method according to claim 14, wherein said metal salts are obtained from calcium magnesium acetate.

26. A method of using the adsorbent of claim 1 to remove hydrogen sulfide from a gas, said method comprising the steps of:
a. contacting a portion of said gas with said adsorbent; and
b. obtaining a treated gas having a lower concentration of hydrogen sulfide than a concentration of said hydrogen sulfide in said gas prior to said contact.

27. A method as in claim 26 wherein said contact is accomplished by using a fixed bed, a fluidized bed, or a moving bed of said adsorbent material.

28. A method of use as in claim 26 to further remove at least one of organic compounds or acid gases from said gas.

29. A method as in claim 28 wherein said organic compounds are organic sulfur compounds.

30. A method as in claim 29 wherein said organic sulfur compounds are selected from the group consisting of methyl mercaptan, dimethyl sulfide, and dimethyl disulfide.
